(19) United States
(12) Patent Application Publication
(10) Pub. No.: US 2011/0188990 A1
(43) Pub. Date: Aug. 4, 2011

(54) BENKATINA HYDROELECTRIC TURBINE: ALTERATIONS OF IN-PIPE TURBINES

(76) Inventor: Daniel FARB, Beit Shemesh (IL)

(21) Appl. No.: 13/020,023

(22) Filed: Feb. 3, 2011

Related U.S. Application Data
(63) Continuation of application No. 12/342,084, filed on Dec. 23, 2008, now abandoned.
Application No. 12/342,084 is a continuation of application No. PCT/IL2007/000770, filed on Jun. 25, 2007.
(60) Provisional application No. 60/805,875, filed on Jun. 27, 2006.
(60) Provisional application No. 60/823,256, filed on Aug. 23, 2006.
(60) Provisional application No. 60/826,927, filed on Sep. 26, 2006.
(60) Provisional application No. 60/864,792, filed on Nov. 8, 2006.
(60) Provisional application No. 60/908,693, filed on Mar. 29, 2007.

(51) Int. Cl. F04D 27/00; B23P 15/02; F04D 29/38

(52) U.S. Cl. 415/1; 29/889.7; 416/182

(57) ABSTRACT

New in-pipe hydroelectric turbine devices, systems, and methods offer the potential for less costly and greater energy output in many applications.

This is a Continuation of U.S. patent application Ser. No. 12/342,084 filed Dec. 23, 2008, which is a National Phase of PCT/IL2007/000770, which claims priority of U.S. Provisional App. No. 60/805,875, filed Jun. 27, 2006, U.S. Provisional App. No. 60/823,256 filed Aug. 23, 2006, U.S. Provisional App. No. 60/826,927 filed Sep. 26, 2006, U.S. Provisional App. No. 60/864,792 filed Nov. 8, 2006, and U.S. Provisional App. No. 60/908,693 filed Mar. 29, 2007.

### FIELD AND BACKGROUND OF THE INVENTION

The present invention relates to a new hydroelectric turbine design that we call a Benkatina Turbine™ and, more particularly, to a hydroelectric turbine with any of a number of characteristics, most particularly designs in which the fluid is recirculated as it passes through the turbine. (The term Benkatina is used in honor of a mechanic of the ancient world named Ben Katin.)

Prior art includes numerous hydroelectric turbines of various designs. None have been found to have the devices described in the current invention.

Most of the hydroelectric turbines available succeed in extracting a small percentage of the energy passing through them. This is due to inefficiencies in any turbine. It is also due to the Betz equation, which limits the amount of energy absorbed by any one turbine as around 59%. The Betz equation assumes an open turbine without recirculation of the fluid containing the energy. One innovation of the current invention is the use of recirculation of the fluid in order to obtain more energy from a fluid flow on each pass of the fluid through the system. Therefore, the Benkatina Turbine is likely to obtain more energy from a smaller turbine area, particularly if several Benkatina Turbines are present in an array. It is intended to be small, scalable, and work particularly well in conditions where excess power is available, such as downhill piping and instream uses. It also enables greater control of water pressure for water engineers. It is particularly useful for conditions where installation costs are high, as in underwater currents, because it can obtain more energy per installation.

It has another advantage over horizontal blade turbines: It does not cause such a large disturbance in the downstream flow. Therefore, the Benkatina turbines can be grouped together more tightly.

Due to being scalable to many sizes, it can have the following applications, among others:

Instream hydroelectric

Dammed hydroelectric

Tidal/ocean currents

Vertical axis wind

Gutter and drain run-off

Piping

Hydroelectric storage

Battery recharging

There is thus a widely recognized need for, and it would be highly advantageous to have, a hydroelectric turbine design that accomplishes more in a smaller space and at a lower cost.

### BRIEF DESCRIPTION OF THE DRAWINGS

The invention is herein described, by way of example only, with reference to the accompanying drawings, wherein:

FIG. 1 is a diagram of a straight-line Benkatina turbine.

FIG. 2 is a 360-degree Benkatina turbine in a superior view.

FIG. 3 is a diagram of different combinations of individual Benkatina turbines.

FIG. 4 is a diagram of an instream arrangement of a Benkatina system.

FIG. 5 is a diagram of a possible topography of Benkatina paddles.

FIG. 6 is a diagram of ways of making the Benkatina paddles.

FIG. 7 is a diagram of the Benkatina turbine used in conjunction with a piston or a plunger.

FIG. 8 is a diagram of the Benkatina turbine used in conjunction with a piston or a plunger in a condition of outflow.

FIG. 9 is a diagram of the Benkatina turbine used in conjunction with a piston or a plunger in a condition of return flow.

FIG. 10 is a diagram of inlets and outlets from a circular Benkatina system.

FIG. 11 is a diagram of a stacked Benkatina system.

FIG. 12 is a diagram of a hydroelectric storage system.

FIG. 13 is a diagram of a hydroelectric system attached to a building gutter.

FIG. 14 is a diagram of a hydroelectric system attached to a street gutter.

FIG. 15 is an engineering diagram of a Benkatina turbine.

FIG. 16 is a diagram of a Benkatina turbine in another configuration of diversions around a center.

FIG. 17 is a diagram of two Benkatina turbines along an omega shaped piping diversion.

FIG. 18 is a diagram of flow diversion.

FIG. 19 is a diagram of hydroelectric storage with a movable inlet/outlet.

FIG. 20 is a diagram of blade profiles.

FIG. 21 is a photo of a built model.

FIG. 22 is a close-up of a movable inlet/outlet.

FIG. 23 is a diagram of turbine vane designs.

### DESCRIPTION OF THE PREFERRED EMBODIMENTS

The present invention is of a hydroelectric turbine which can be used to increase the amount of energy obtained from a large number of flow situations and exert greater control over the production of electricity.

Definitions: Fluid or flow can refer to any liquid or gas. In this discussion, we may refer to water, as the most common example of a fluid, but gas is also treated as a fluid scientifically, and all references to fluid include any type of fluid flow including gas unless otherwise specified. “Benkatina turbine” can sometimes refer to an individual turbine with the characteristic of recirculation of the fluid flow and to a system of at least two turbines. Paddles are considered to be a kind of “blade” but they are considered to have a rotational axis in the y-axis in relation to the x-axis of flow. A propeller blade has a rotational axis in the x-axis of the flow. Paddle wheels consist of several paddles. Each paddle has a rotational axis not in the x-axis of flow, but usually perpendicular to it. A “Benkatina pipe” is a main chamber/side chamber arrangement that can contain a Benkatina turbine. Recirculation means that some of the fluid that has passed through a turbine is routed to a point from which it reenters the turbine.

The principles and operation of a Benkatina hydroelectric turbine according to the present invention may be better understood with reference to the drawings and the accompanying description.

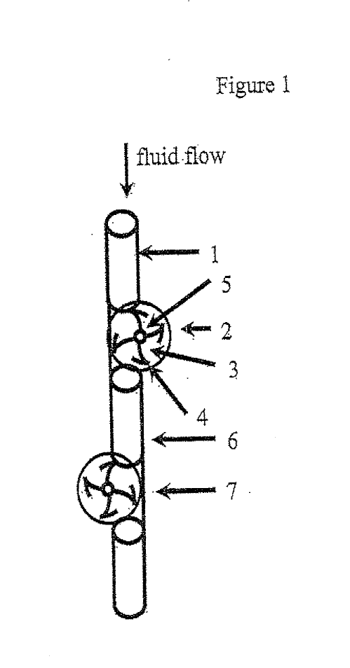

Referring now to the drawings, FIG. 1 illustrates a substantially straight-line Benkatina turbine. FIG. 1 illustrates one of the basic points of the current invention: a main chamber (1) and a side chamber (2) where at least a part of the fluid flow (3) can make a circuit before being returned to the main chamber (6). Some of that flow hits one paddle and proceeds straight while some is diverted into the adjacent circular side chamber. Flow through a pipe or other means (1) turns at least one paddle (4) in the pipe pathway. Part (5) is the hub of the paddles. It is connected to a generator. Ideally, the main and side chambers are of the same diameter throughout. (The diameter as referred to here is the distance from the hub to the outside of the side chamber; that would be the radius of the turbine. In general, the side chamber is twice as wide as the main chamber.) The side chamber could also be of lesser or greater diameter than the pipe in other embodiments. One of the other unique points of the patent is placement of two turbines, ideally Benkatina types, in proximity to each other within the same system, as in parts (2) and (7). Ideally, the proximity is within 3 diameter lengths of the turbines, but it can be more or less. This enables greater control of the amount of energy removed from the flow within a small area. The two Benkatina turbines, as shown here (2, 7), are on different sides of the main chamber; they may be on any side of the main chamber from each other. The paddle (4) ideally nearly fills the interior of the side chamber. Part (1) shows the main chamber. It can be part of a longer section of pipe of the same diameter, or connected to an inflow pipe of a different diameter. The ideal is that the passageways within the Benkatina section itself are equivalent in size.

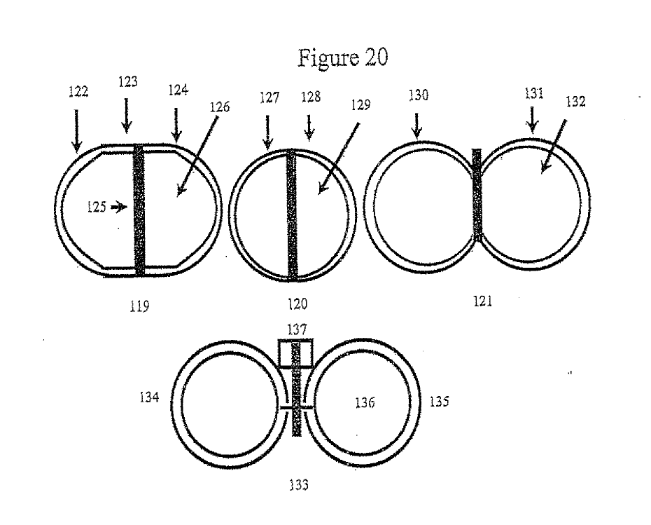

The turbine has an axis at the interface of the main and side chambers. This interface location is defined as being in the imaginary point where the wall of the main chamber would have continued had a side chamber not been formed, and in the middle of the gap along the width of the opening between the main and side chamber. This could assume several positions, as FIG. 20 will show.

The exterior of the main and side chambers can be solid, or solid frame with lighter material attached.

Note that FIG. 1 shows the imaginary continuation of the outline of the side chamber within the main chamber; in reality, it does not block the main chamber.

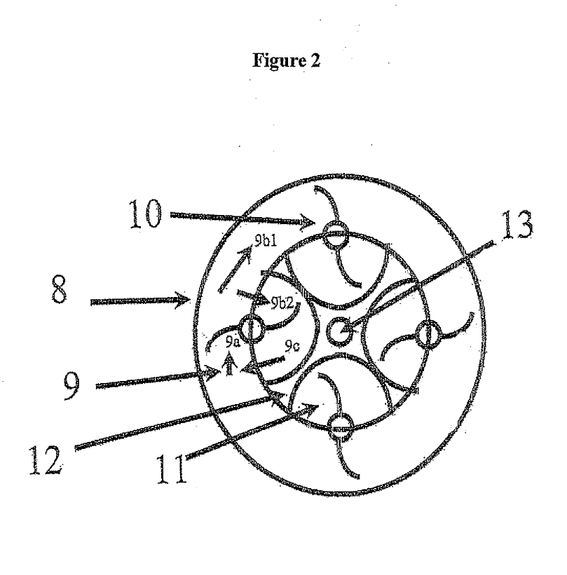

FIG. 2 is a 360-degree Benkatina turbine (8). As shown before, it has side chambers (11) adjacent to the main flow chamber (9). The fluid in the main flow chamber (9a) proceeds forward into (9b1) or recirculates in path (9b2), from which the makes a turn (9c), and re-enters the main flow chamber (9), where it takes path (9a). Clearly, this will happen most efficiently if the area is entirely saturated with fluid. Each internal circular path has at least one paddle rotating around a hub (10), which is ideally located at the middle of the main and side chambers. Each hub is connected to a shaft and a generator for the production of electricity. Ideally, there are four Benkatinas within the larger circular Benkatina. The central shape is ideally hollow in areas (12) between the side chambers and the center. In one embodiment, a central generator (13) also is capable of movement and electricity generation from the torque on the external paddles of the side chambers. This may lead to greater utilization of the energy in the fluid flow.

Another variant of the Benkatina is round in the shape shown in FIG. 2, but the outer and inner chambers are not circular, but rather some other shape, such as cylindrical. In that case, the height of the whole turbine displayed in FIG. 2 would be greater than the width. This is not visible from the picture, which is a superior view. A Benakatina turbine of the type shown in FIG. 2 with a greater height than width could be used in certain applications, such as rivers, so that a larger volume can pass through the turbines in a shape that is higher than it is wide. The inlets and outlets should be arranged accordingly. Some arrangements will be shown later. Ideally, both vertical and horizontal diameters will remain the same within the Benkatina Turbine.

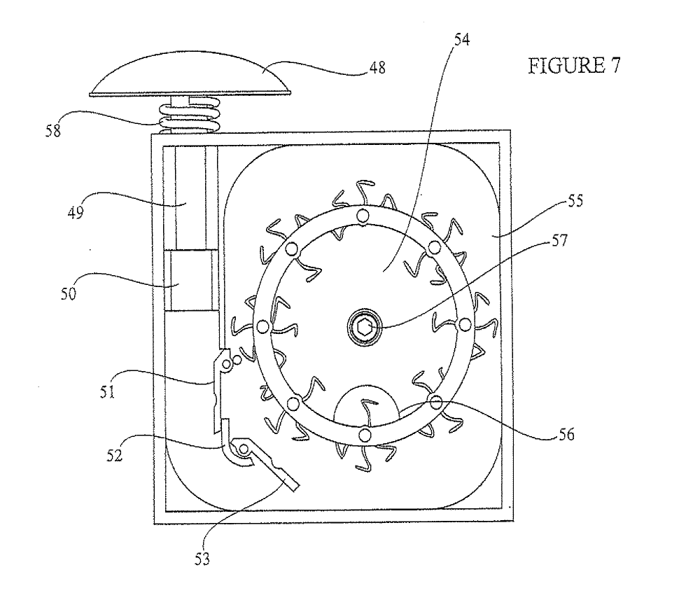

One novelty of the Benkatina turbine system variation shown in FIG. 2 is the capture of energy in at least two rotational axes simultaneously by the translation of power from the outer turbines to the inner one (when the inner hub rotates). An additional optional but important feature is the nearly 360 degree passage through the system. This enables at minimum the improved capture of energy from pressures that are great compared to the size of the turbine, as when a person is applying pressure to a relatively small object as in FIG. 7, but it is also possible that the Benkatina turbine is slightly more efficient than others because its nearly 360 degree flow through the rotational axes absorbs a higher percentage of thermodynamic energy by means of a reduction in turbulent flow and by capturing the energy otherwise spent on torquing paddles connected to the center of a turbine. Because of this unique design, it is possible that a Benkatina turbine in a substantially horizontal orientation can improve the process of obtaining hydroelectric energy from dams and other bodies of water. It can also be used with flows of gas.

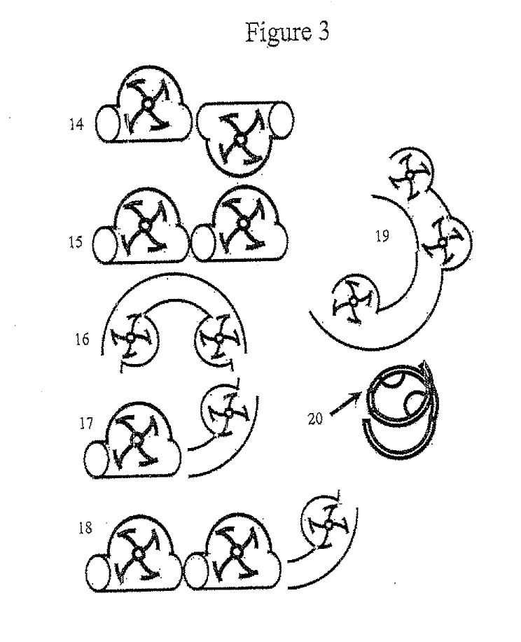

FIG. 3 is a diagram of different combinations of individual Benkatina turbines. (14) is a straight line arrangement of two individual turbines on a different side of the main chamber. (15) is a straight line arrangement of two individual turbines on the same side. (16) shows a curved main chamber with two individual turbines on the inside. The theoretical advantage of this arrangement is that, where the blades are designed appropriately, it takes greater advantage of the faster flow on the outside of the curved main chamber. (17) and (18) show combinations of straight and curved Benkatinas. (19) shows arrangements of Benkatinas around a curve in a pipe. The individual turbines can be on different sides of the main chamber. The individual turbines can be on the same side of the main chamber. (20) shows a main chamber in the shape of a corkscrew. As the elevation of the main chamber changes and winds down, at least one turbine can be placed off the main chamber.

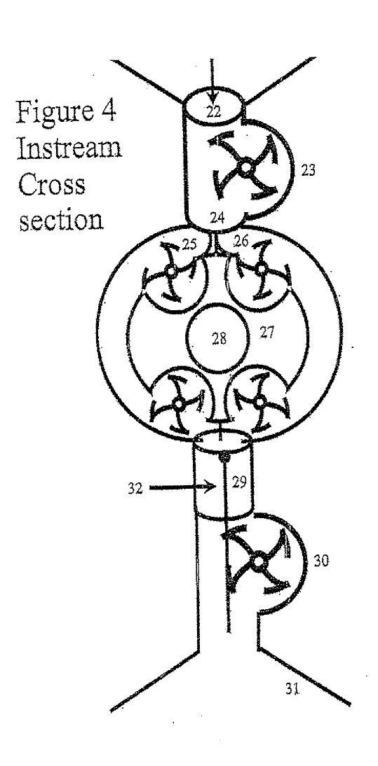

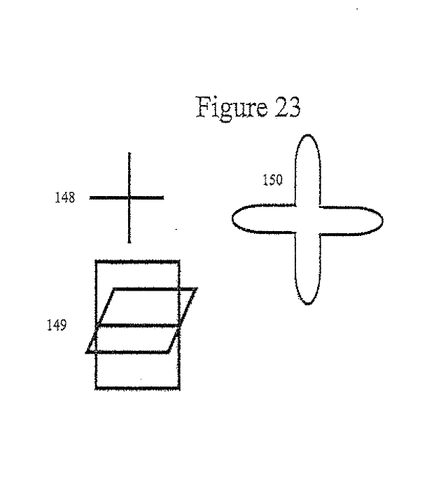

FIG. 4 is a diagram of an instream arrangement of a Benkatina system. This and similar arrangements could be used for river and ocean current flows. The flow enters from the top through initial main chamber (22). There is an optional collector (21) attached to the intake. In one embodiment, the initial main chamber has a Benkatina turbine (23) followed by a continuation of the initial main chamber (24). The flow now divides into secondary smaller main chambers (25) and (26). Along these chambers can be at least one Benkatina turbine. In the ideal configuration, the secondary smaller main chambers rejoin to form a final main chamber (29), which may also have at least one attached Benkatina turbine (30) in one configuration. The outlet may have an optional diffuser (31). This system may be used for tidal currents and may be fixed in place, and use two-way paddles or two-way generators. In the ideal configuration, part (28) is the supporting structure or tower for the turbine system. (27) is the hollow area on the inside of the system. (28) may be rigidly attached to the system, or free to allow rotation. In the case of rotation around a central axis being permitted, the optimal angling of the turbine system may occur either through electronic control and sensors, or by means of a tail and vane (32). The vane may be attached in a number of places on the system. If the size of area (27) is sufficient, the turbine may also adapt vertically to changes in current flow using a vane as described later in FIG. 23.

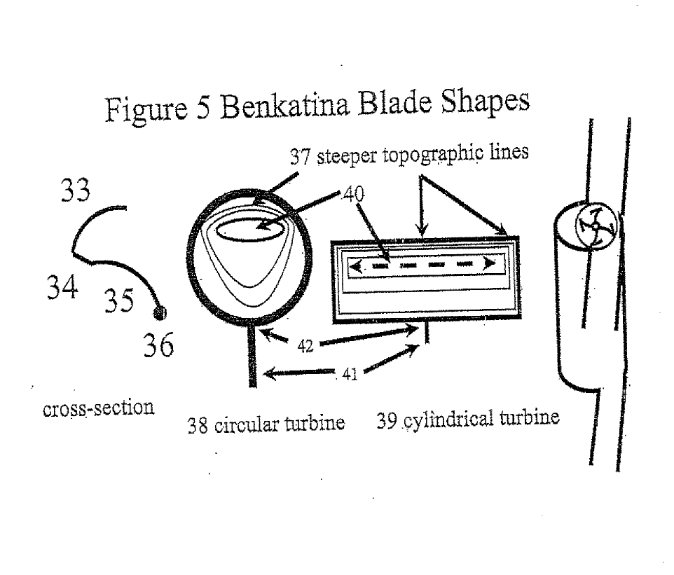

FIG. 5 is a diagram of a possible topography of Benkatina blades. Many shapes can be used. Ideally, whatever shape is used will have some of the characteristics shown in this figure. This figure illustrates the concept of pushing the flow and the torque into the periphery of the blade—or, in its ideal embodiment, paddle. The arrangement shown can be used with other types of turbines.

The shape of the blades is important in order to maintain maximal flow. FIG. 5 shows that a cross-sectional arrangement of points (33), (34), and (35) is ideal for enhancing the natural tendency of the flow to the outside of the blades in a circular environment. Pushing the flow in that direction increases the torque and the energy to captured. Part (35) is the shape attached to the central rotation point (36), which drives a shaft and a generator. Point (34) is a substantially straight area, ideally at 90 degrees from the edge of part (33). The outer edge of part (33) is congruent and close to the outside wall of the chambers. Part (34) can be left out and part (35) could continue in its arcuate shape till it meets part (33). Part (35) is ideally convex to the direction of flow. Of course, other shapes can be used with the turbine, but the shapes just described offer a theoretical advantage.

The topography of the blades also forces the flow to the periphery, in the ideal embodiment. The picture shows examples of topographic lines, with the outer edge being the steepest, in both circular (38) and cylindrical (39) paddles. In general, the periphery has a steeper topography (37) and the deepest part is in the peripheral half (40). In the circular turbine (38), that steeper edge ideally consists of no more than the outer half of the paddle blades. In a cylindrical turbine (39), the shape of the paddle blades is ideally rectangular along the outline, with the steepest portion towards the periphery of the blades, and ideally no more than halfway towards the inner portion on the sides. In the circular turbine, the topographies are ideally parabolic in outline. (41) attaches the paddle to the central hub. (42) is the medial part of the paddle. As shown, this is for a pipe and turbine that are cylindrical shaped in order to accommodate a situation when a cylindrical configuration is more appropriate, such as certain instream situations.

In summary, the ideal Benkatina paddles in cross-section consist of two arcs at a minimum; the outer arc (33) is parallel to outer circle of the circular chamber in all its periphery and nearly at the edge of the chamber. The other arc (35) is convex to the flow, and connects from the edge of the outer arc to the center point, in some cases with a radially oriented portion (34) in between. In a cylindrical turbine with a rectangular outline to the paddle, there are 3 sides (the periphery and two sides) with a steep topography in the peripheral half of the paddle.

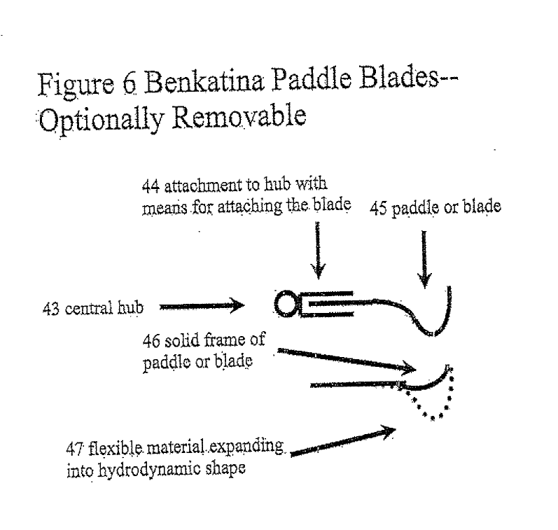

FIG. 6 is a diagram of ways of making the Benkatina paddles. In one embodiment, the paddles are removable. This can be an aid for maintenance. (43) is a central hub, attached to a shaft and generator. (44) is a piece attached to that in a radial orientation that contains means for attaching the paddle (45). An alternative system for the paddles can comprise a solid frame (46) with a flexible interior (47). That flexible interior can be taut or not taut. If that flexible interior is not taut, then it can assume a hydrodynamic shape from the pressure of the flow. In one embodiment, it can do so in each direction. This would have the advantage of making a lighter paddle, which might have the disadvantage of being less durable. A method for easy replaceability could solve the problem.

FIG. 7 is a diagram of the Benkatina turbine used in conjunction with a piston or a plunger. FIGS. 7, 8, and 9, use a picture with a plunger apparatus, but any kind of piston device is equivalent. (48) is a plunger, or other device to generate linear movement of fluid or pressure. In other embodiments of the Benkatina Turbine, the external pressure can come from other sources, such as a stream of water, a piston, or a compressor. An optional spring (58) helps the plunger return to position for another application of pressure. Part (49) is an enclosed area for a piston (50). A fluid (51) is present on the inside. The piston presses against that fluid. The basically linear force of the piston pushes the fluid through a one-way valve (53). The fluid then returns through a separate one-way valve (52) after passing through an array of small turbines contiguous to the fluid interior (55). The small Benkatina turbines are located at the periphery of a ring or cylinder with their hubs on the outside of the ring. These small Benkatina turbines may have a side chamber (56) in their ideal embodiment, or may move through an unenclosed environment (54). In the case of an unenclosed environment, the interior fluid (54) could be lighter than the exterior (55), and attracted to a hydrophobic or hydrophilic surface attached to the interior of the ring. In another embodiment, the central hub may also rotate and turn a shaft and generator. The contents are a liquid, in different embodiments water or hydrophilic, oil or hydrophobic, or both.

The smaller wheels are located in openings of the larger wheel at the periphery, that is, sandwiched between the outer flat edges. The edges of the main channel for fluid flow (55) are ideally curved. Ideally, the inflow (53) and outflow (52) are designed so that the flow makes nearly a 360 degree circuit around the energy capture device. In FIG. 7, it is possible for the water to continue circulating beyond 360 degrees. In various embodiments, the central cylinder is solid or, ideally, hollow and contains no fluid, so that the friction is reduced, and it connects to the outer wheel through radial connections. So the basic shape of the whole device is a flattened cylinder. The outside of the cylinder can have a solid, planar connection to the center on the base and apex of the cylinder, or it can be connected through radial spokes, like an old wagon wheel of a carriage, to the base and apex of an outside hollow cylinder. In either case, the size of the blades of the outer turbines are ideally similar to the size of the outer chamber, so that virtually all flow contacts the outer paddles. Tiny generators connect to each turbine's axis of rotation, including, optionally, the center of the cylinder.

The position of the one-way valves increases the pull on the circulating fluid in the desired direction. Circulation is maintained in the same direction in FIG. 7 by the two levers or valves located below the piston. Any other one-way valve can be used in place of these levers. When the push-down occurs, the lower lever (53) opens and flow can go through. The upper lever (52) stays closed since flow forces it to stay as is. When the pressure from the knob is released, the spring (58) forces the piston or plunger (50) upwards. At that time, flow circulation is maintained and suction occurs under the piston. Such suction causes the opening of lever (52) and closing of lever (53).

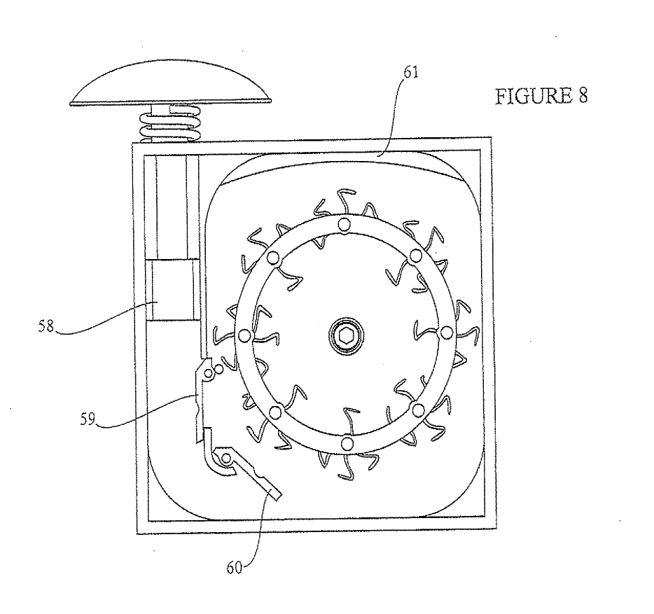

FIG. 8 is a diagram of the Benkatina turbine used in conjunction with a piston or a plunger in a condition of inflow.

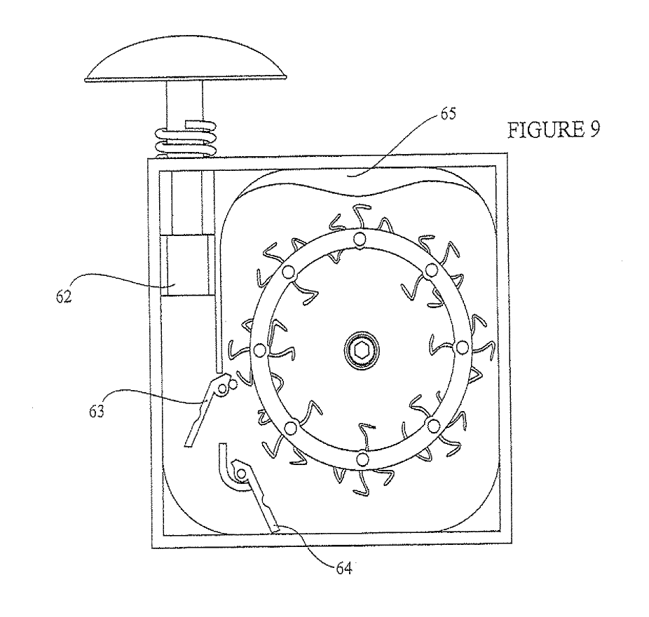

FIG. 9 is a diagram of the Benkatina turbine used in conjunction with a piston or a plunger in a condition of outflow from the turbine or return flow to the piston area.

FIGS. 8 and 9 show the concept with an air membrane that moves when the plunger is pushed in and pulled back. In FIG. 8, the plunger is pushed down. That pushes down the piston (58) and forces open the lower lever (60) while closing the upper lever (59). The flexible membrane (61) expands. In FIG. 9, the plunger and the piston (62) move out. This movement causes the upper lever (63) to open and the lower lever (64) to close. The flexible membrane (65) moves inwards. The membrane is only one possible solution. Other means for adjusting the pressure changes are possible, such as an adjacent reservoir of fluid.

The mechanical device in the pressure plunger turbine as shown causes the fluid to run around the Benkatina Turbine. Fluid may be hydrophobic, hydrophilic, or both. As water and oil are not compressible liquids, there is a need to leave room for the pressure increase and decrease. For that purpose a membrane structure is one means to absorb the non-compressible liquid movement and allow the circulation. This membrane on the top of the box divides the liquid from the air and is flexible.

In FIG. 9, the membrane should only come inside far enough so that it does not contact the paddles. It is shown as very close in this figure to illustrate the movement of the membrane.

This membrane is not necessary for other uses of the Benkatina Turbine, such as hydroelectric.

Power calculations

The power that comes out of the rotational movement of the Benkatina

Turbine, in the miniature plunger shown in FIGS. 7-9, is a mixture of two kinds of rotations. The piston pressure exerts force on the small paddles by the fluid flow.

Assuming that:

The piston displacement is 50 mm

Starting from zero velocity

It takes 0.3 sec to move the piston down

The velocity (at the bottom) will be

Vᵢ=V₀+a×t

when using for simplicity the formula

a=3g=3*9.8=29.4 m/sec²

V₁=0+29.4×0.3=8.8 m/sec

This size of velocity generates mass flow accordingly.

m=ρ×V×A

If we take for room temperature ρ=997 kg/m³ for water

And

The area of the single paddle A=0.000225 m2

We get

Φ=997×8.8×0.0025=1.97 Kg/sec

The force acting will be

F=ρ×V²×A=1.1 N

and the power each wheel generates

P=V×F=9.7 Watt

For each push down, a wheel with 8 paddles can produce about 80 Watts.

While the force is exerted on each paddle, some of it goes to the large wheel (in the condition where part 57 also rotates) and rotates it in the same direction if it is not fixed. The rotation of large wheel is proportional to the outer liquid circulation.

The boundary layer which causes the drag force on the paddlewheels can be lowered by using less dense liquid inside the Benkatina Turbine. The quantities of each liquid used will be determined by the volume of fluid inside the outer circumference of the turbine, not including the outer channel. That will help to reduce friction while the paddles are turning.

The current invention is more effective than a wheel with stationary paddles alone because it maintains laminar flow and relatively stable boundary layers around the wheel, in addition to its capture of a greater amount of the flow energy.

When the configuration of FIGS. 7-9 is used as a battery recharger device, it may be enhanced for commercial use by making one side clear, using bright colors for the fluid and parts, and making it enjoyable for users to watch the moving parts. It could be used for many other piston applications on a larger scale. Because of the high density of water, it may help to reduce space used with other piston/compression arrangements.

In one embodiment, a series of hydrophilic and/or hydrophobic surfaces deliver an increase in efficiency by directing the denser fluid to the outside, so that the less dense fluid on the inside of the larger wheel decreases the resistance on the smaller wheels. Density may be further increased in the denser fluid by the use of solutes.

In embodiments of any of the devices and systems in contact with fluid or water in an energy capture system, hydrophilic and hydrophobic coatings may be used. This may aid in directing flow, protecting against corrosion, and increasing speed.

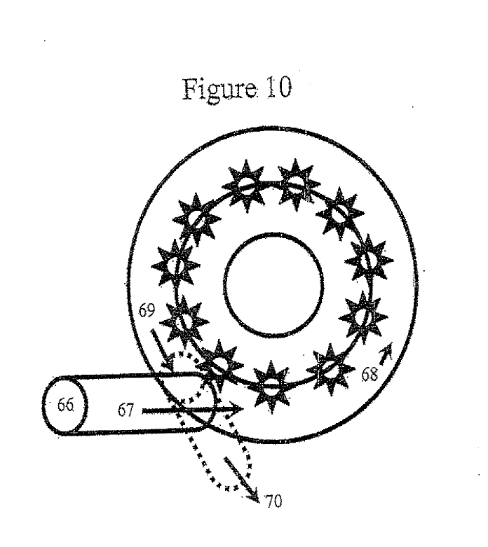

FIG. 10 shows the inflow and outflow into a substantially flat Benkatina turbine system and shows how the outflow can continue in any direction from the inflow. At least one one-way valve or means such as a wall at the end of the 360 degree circuit will limit interference by flow from the outflow tube. Such a one-way means may be located at the external inflow and outflow tube periphery rather than inside the turbine itself. It may be used to capture vertical energy from a dam, river, or other situation of falling water by having inlet and outlet tubes that are ideally angled at slightly greater than zero degrees above the horizontal as in FIG. 10, where tube (66) is intended to display the angle of the tube above the flat Benkatina system. The fluid then continues through points (67-70) and outward inferiorly.

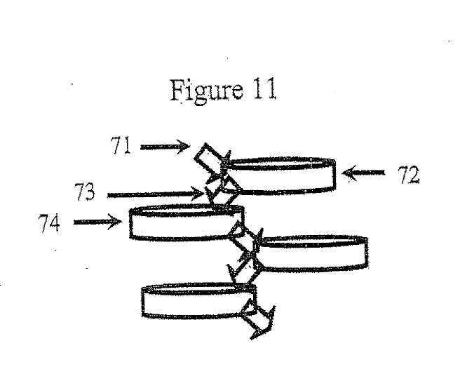

These systems can be used in a stack of connected turbines, the outflow from one descending to the inflow of the next, as in FIG. 11, where inlet (71) leads to turbine (72), to outlet (73), and into turbine (74). The gentle nature of the flow as compared to other methods of generation of hydroelectric power may result in a more efficient conversion of energy from the descent of the water.

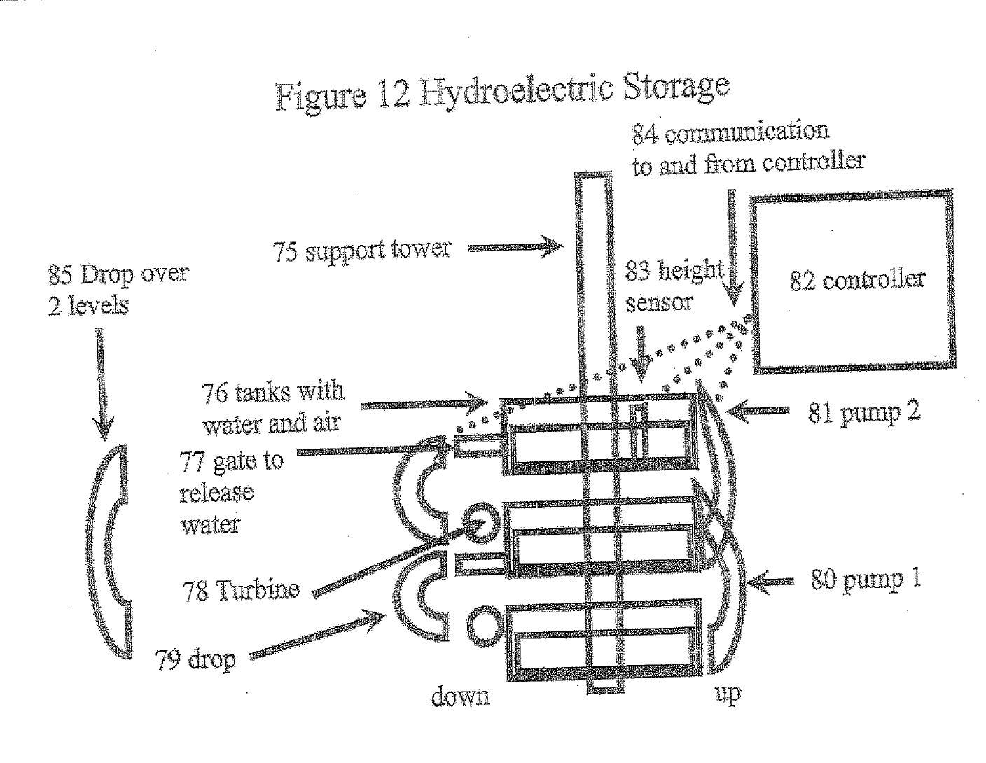

FIG. 12 is a diagram of a hydroelectric storage system. (75) is a support system or tower. (76) shows tanks with water and air, but it could be any liquid and gas. Each tank has an outlet (shown here on the left) and an inlet connected to a pump (shown here on the right as 80 and 81). The tanks may be connected in any of several fashions—directly to the one above, or to one several steps up, etc. Each outlet requires a gate (77) to release liquid through a rigid or non-rigid pipe (79, 85) through a turbine (78) into a lower tank. Many combinations of tanks, drops, and pumps can be used. Ideally the gates and pumps are under electronic controls (82) that obtain input (84) from sensors (83) of the height of the liquid and respond to inputs regarding the need for energy.

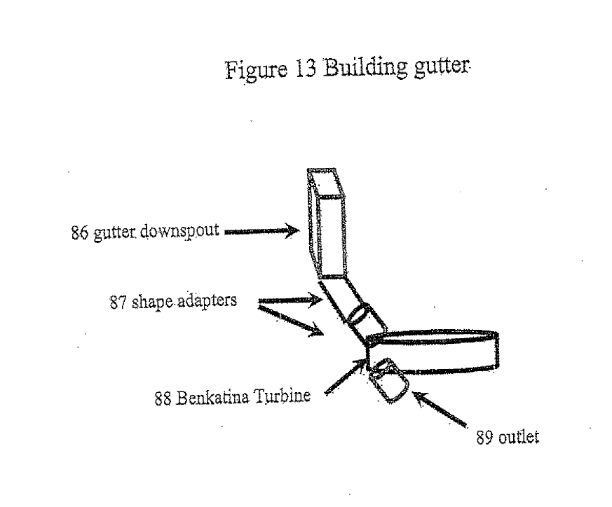

FIG. 13 is a diagram of a hydroelectric system attached to a building gutter. The attachment of a turbine to a building gutter is a new concept. The figure illustrates how a turbine, ideally a Benkatina Turbine, can be fitted to a downspout (86) of a house or commercial building. A connecting piece or pieces (87) are required to provide entry of the water into the turbine (88). In the ideal embodiment, a flexible tube surrounds the gutter outlet and converts the contents into circular flow (since many gutters are not circular in cross-section) by attaching to a rigid circular pipe at the other end. The circular pipe feeds into the turbine. In other embodiments, other kinds of pipe can be used. After turning nearly 360 degrees in the Benkatina Turbine, the water exits (89). Any of the other Benkatina variants can be used as appropriate.

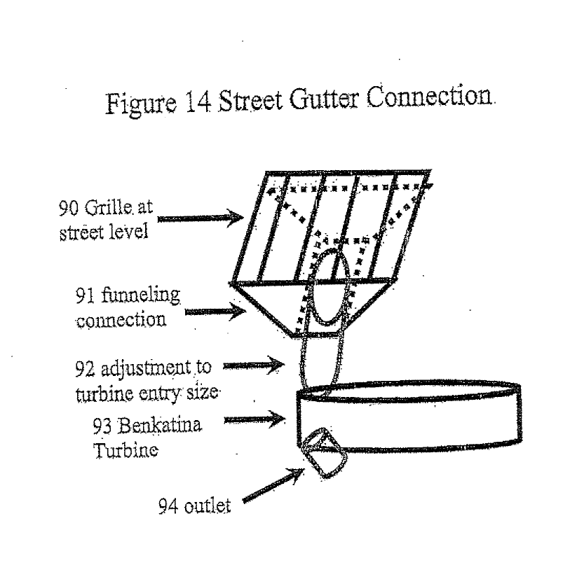

FIG. 14 is a diagram of a hydroelectric system attached to a street gutter. The attachment of a turbine to a street gutter is a new concept. The figure illustrates how a turbine, ideally a Benkatina Turbine, can be fitted to a street system. The grille (90) empties into a funneling connection (91) that adapts (92) to the shape of the turbine (93), which is ideally suspended from the grille or other structures on the street gutter, so that it is below the level of the street. (94) is the outlet from the turbine. Ideally, the funneling could be shaped so it is somewhat parallel to the direction of typical inflow to the gutter so that velocity of the liquid is maintained.

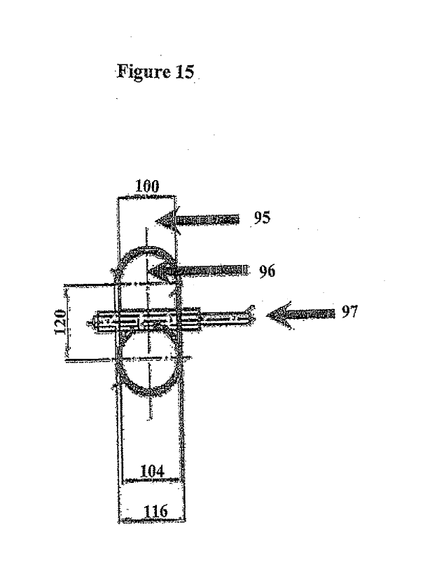

FIG. 15 is an engineering diagram of a Benkatina turbine. (95) is the main chamber. (96) is a side, cut-away view of the side chamber where it meets the main chamber. (97) is the shaft connected to the middle of the paddle wheel that transmits rotational motion to a generator.

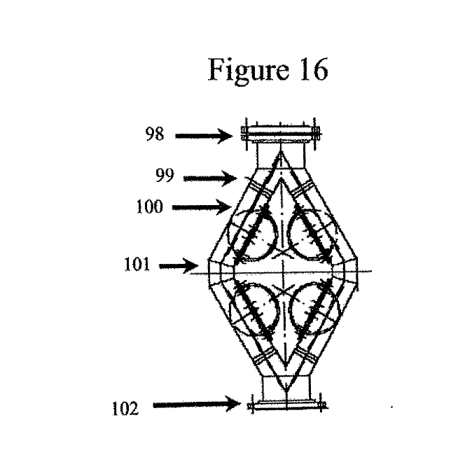

FIG. 16 is a diagram of a Benkatina turbine in another configuration of diversions around a center. This could be used for instream or for piping. (98) is either the entry pipe connection or the entrance of instream fluid. At point (99) the flow diverges into two streams, ideally each half the size of the original inlet. Each flow passes through at least one turbine (100). (101) is a piece of piping that changes the direction of the piping from outward to inward so that the two streams of flow can rejoin at areas (102) and exit or rejoin a piece of piping. An optional valve or blockage may be placed at point (99).

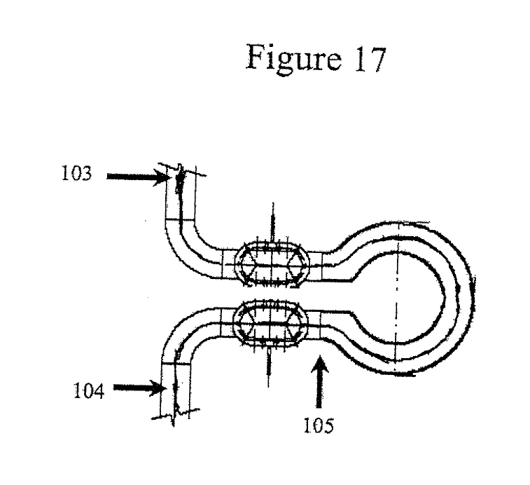

FIG. 17 is a diagram of two Benkatina turbines along an omega shaped piping diversion. (103) is the inlet and (104) the outlet. The omega shaped area (105) allows the addition of several turbines within a small distance from one part of the straight pipe (103) to the other (104).

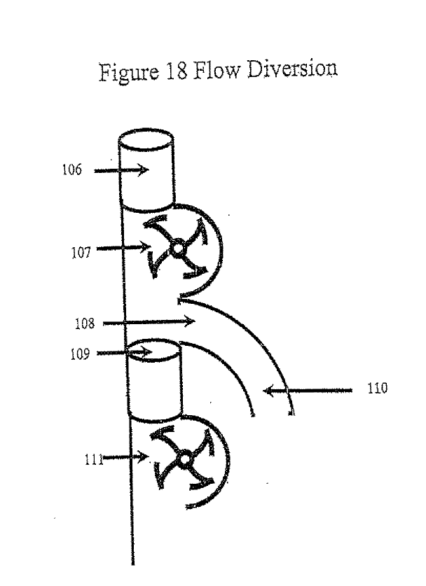

FIG. 18 is a diagram of flow diversion. This addresses the issue of allowing a lower cut-in speed by directing the fluid either through only one turbine and then the exterior or the continuation, or by directing the fluid through an additional turbine before continuing. Thus, this turbine system can handle a wider range of fluid speeds than currently available turbines. This is ideal for variable underwater currents. The fluid enters through chamber (106). It passes through turbine (107). Here it is shown as a Benkatina Turbine, but it could in other embodiments be any other turbine. The fluid then has a choice of paths, either through points (109) and (111) through a second turbine, or through point (108) and chamber (110) to exit or continue. If the flow is slow, it will not have the force to move through point (109) but will exit through (108). Particularly if the chambers are the same size, point (109) will act as dead space, and the flow can proceed through (108). If the flow has greater force, it will proceed through (109). What has been described is a way of accomplishing flow diversion and a wider range of cut-in speeds automatically, but other means would be more precise. Such means could include valves and passageways under electronic and mechanical control, or turbine components that engage and disengage. (108) and (109) would be likely points to place flow or pressure sensitive valves.

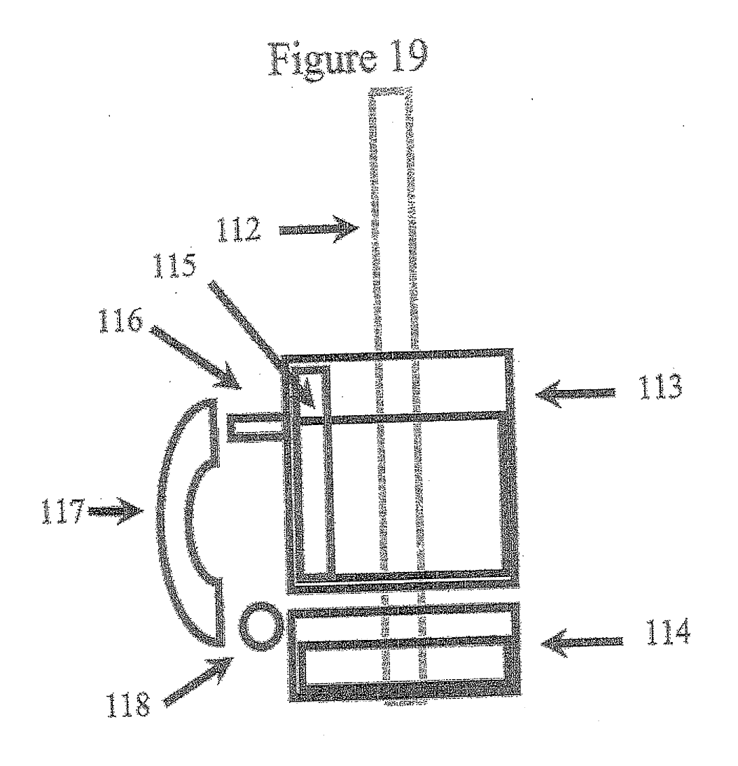

FIG. 19 is a diagram of hydroelectric storage with a movable inlet and, optionally, outlet. The idea here is that fluid can be discharged in small increments with the maximum head. (112) is the tower. (113) is the upper tank and (114) is the lower tank. (115) is a track for the outlet gate (116) to move in. (117) is a flexible hose that connects to a turbine in a lower tank or other receptacle (118). The outlet gate (116) is controlled to provide fluid from the upper section first. Not shown, for reasons of clarity, is the inlet into the upper tank from the lower tank. That inlet has a similar appearance, except that it has a pump to direct fluid upwards instead of a turbine, and that the inlet is above water level.

A movable inlet can work much the same way except to provide water, with a control that ensures that the inlet is always located with its lowest point just above the upper surface of the fluid. Said control can be a flotation device. The inlet follows a track such as part (115). A pump replaces the turbine at position (118), except that it is always position to take in from below the water level and move into the upper tank through position (116) above the water level.

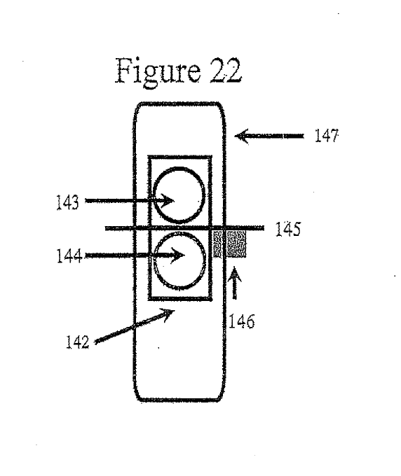

FIG. 22 is a close-up of a movable inlet/outlet. (147) is the guide or track. (142) is the piece holding the inlet (143) and outlet (144) together near the surface of the liquid (145), so that the inlet is just above the liquid surface and the outlet just below. The outlet will have a control valve at some point to prevent opening until outflow is needed. A floating means (146) is attached to part (142).

FIG. 20 is a diagram of blade profiles for a Benkatina turbine. According to the present invention, the central shaft and side chambers could contact the main chamber at a number of different locations (pictures 119, 120, and 121) but the ideal configuration is picture (133) because of its symmetry and maintenance of the same flow shape as the main chamber (135) within the side chamber (134). In addition, it allows for more compact placement of the shaft and generator (137). In the other pictures in this figure, (125) is the central shaft; (124, 128, and 131) are the main chambers; (123, 127, and 130) are the side chambers of different shapes, (126, 129, and 132) are the blades of different shapes; (123) is a small linear extension of the chambers in that particular design.

We define the side chamber as consisting of the passageways shown in FIG. 20, even if the side chamber assumes a tubular shape connected only by the rod to the blades, and not directly contacting other parts of the side chamber, as in picture (133).

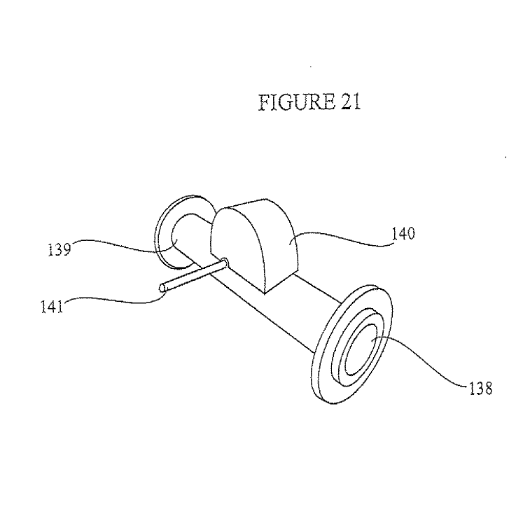

FIG. 21 is a photo of a built model of a 4-inch diameter pipe. (138) is the inlet or outlet. (139) is the main chamber. (140) is the side chamber. (141) is the shaft to be connected to the generator.

FIG. 23 is a diagram of turbine vane designs. A vane with 4 sides at 90 degrees from each other will enable vertical tilting of a turbine in the direction of flow as well as the common horizontal tilting. This can apply to any turbine. Parts (148), a cross-section, and (149), a side view, illustrate this. Another type of vane (150) can be used with turbines like the Benkatina that enclose the fluid and can also perform the function of a diffuser at the same time. It can have at least two sides, preferably four, and simultaneously function to orient the turbine.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a turbine that works in a piping system in addition to its applications.

It is now disclosed for the first time a piping system, comprising:

a. A pipe section containing an in-pipe turbine, which section comprises at least one alteration to the standard pattern of substantially horizontal linear flow in a rigid pipe of equal diameter substantially before and after the turbine.

In one embodiment, the system further comprises:

b. A flanged pipe wider than and attached to the central flow into the turbine.

In one embodiment, the system further comprises:

b. At least two turbines connected by a main chamber,
c. An alternate path of piping exiting between the first and second turbine, said alternate path connected to the main chamber on one end and having an outlet without a turbine on the other.

In one embodiment, the system further comprises:

b. An intake,
c. At least two pipes dividing from the intake, at least one of which has said turbine

In one embodiment, the above system further comprises:

e. A central supporting structure substantially adjacent to the division of the two pipes from the intake.

In one embodiment, the system further comprises:

b. A diffuser at the outlet of said turbine system, said diffuser having at least two radial sections, each section located approximately circumferentially equidistant from each other.

According to another embodiment of the above system, the diffuser comprises at least four sections.

In one embodiment, the system further comprises:

b. A main chamber with a substantially 360-degree turn with a non-horizontal axis,
c. At least one turbine connected to the main chamber.
9. The system of claim 1, comprising:
b. A gutter,

In one embodiment, the system further comprises:

b. A second turbine, originating from the main chamber or its continuation within 5 main chamber diameters of the end of the first turbine.

In one embodiment, the system further comprises:

b. A substantially semicircular, side chamber in communication with the main chamber along at least part of the area between two straight lines of the main chamber wall, wherein said side chamber has an axis not substantially parallel to the direction of main chamber flow, wherein the main chamber cross-section is substantially rectangular in a plane perpendicular to the direction of flow and the side chamber is substantially a partial cylinder.

In one embodiment, the system further comprises:

b. A two-way generating means attached to the said turbine.

In one embodiment, the system further comprises:

b. A paddle comprising an area of steeper topography and greater depth in the concave orientation to the flow at the near-periphery of the paddle blade than in the center, said greater depth substantially existing in the outer half of the blade.
c. A convex section of the paddle located in the central section of the paddle.

In one embodiment, the system further comprises:

b. At least one of the inlet or outlet capable of vertical movement.

In one embodiment, the above system further comprises:

c. A flotation device attached to the inlet and/or the outlet, said flotation device operative to maintain the outlet just below the surface or the inlet just above the surface of a pool of fluid.

In one embodiment, the above system of vertical movement further comprises:

c. A flexible section of the pipe material used in flow to or from the storage structure.

According to another embodiment of the above system of vertical movement, the fluid recirculates.

It is now disclosed for the first time a method of varying the operation of an in-pipe turbine, comprising:

a. Opening and blocking passageways for the fluid.

It is now disclosed for the first time a method of manufacturing a vane for a turbine, wherein the exit structure of the turbine also serves as the vane. Numbers in parentheses refer to the figures.

What is claimed is:

1. A piping system, comprising:
a. A pipe section containing an in-pipe turbine, which section comprises at least one alteration to the standard pattern of substantially horizontal linear flow in a rigid pipe of equal diameter substantially before and after the turbine.

2. The system of claim 1, further comprising:
b. A flanged pipe wider than and attached to the central flow into the turbine.

3. The system of claim 1, further comprising:
b. At least two turbines connected by a main chamber,
c. An alternate path of piping exiting between the first and second turbine, said alternate path connected to the main chamber on one end and having an outlet without a turbine on the other.

4. The system of claim 1, further comprising:
b. An intake,
c. At least two pipes dividing from the intake, at least one of which has said turbine

5. The system of claim 4, further comprising:
e. A central supporting structure substantially adjacent to the division of the two pipes from the intake.

6. The system of claim 1, further comprising:
b. A diffuser at the outlet of said turbine system, said diffuser having at least two radial sections, each section located approximately circumferentially equidistant from each other.

7. The system of claim 6, wherein the diffuser comprises at least four sections.

8. The system of claim 1, further comprising:
b. A main chamber with a substantially 360-degree turn with a non-horizontal axis,
c. At least one turbine connected to the main chamber.

9. The system of claim 1, further comprising:
b. A gutter,

10. The system of claim 1, further comprising:
b. A second turbine, originating from the main chamber or its continuation within 5 main chamber diameters of the end of the first turbine.

11. The system of claim 1, further comprising:
b. A substantially semicircular, side chamber in communication with the main chamber along at least part of the area between two straight lines of the main chamber wall, wherein said side chamber has an axis not substantially parallel to the direction of main chamber flow, wherein the main chamber cross-section is substantially rectangular in a plane perpendicular to the direction of flow and the side chamber is substantially a partial cylinder.

12. The system of claim 1, further comprising:
b. A two-way generating means attached to the said turbine.

13. The system of claim 1, further comprising:
b. A paddle comprising an area of steeper topography and greater depth in the concave orientation to the flow at the near-periphery of the paddle blade than in the center, said greater depth substantially existing in the outer half of the blade.
c. A convex section of the paddle located in the central section of the paddle.

14. The system of claim 1, further comprising:
b. At least one of the inlet or outlet capable of vertical movement.

15. The system of claim 14, further comprising:
c. A flotation device attached to the inlet and/or the outlet, said flotation device operative to maintain the outlet just below the surface or the inlet just above the surface of a pool of fluid.

16. The system of claim 14, further comprising:
c. A flexible section of the pipe material used in flow to or from the storage structure.

17. The system of claim 14, wherein the fluid recirculates.

18. A method of varying the operation of an in-pipe turbine, comprising:
a. Opening and blocking passageways for the fluid.

19. A method of manufacturing a vane for a turbine, wherein the exit structure of the turbine also serves as the vane.
